(19) United States
(12) Patent Application Publication
(10) Pub. No.: US 2025/0345999 A1
(43) Pub. Date: Nov. 13, 2025

(54) METHOD AND DEVICE FOR REMOVING RESIN ADHERING TO ADDITIVELY MANUFACTURED COMPONENTS

(71) Applicant: CUBICURE GMBH, Wien (AT)

(72) Inventors: Markus KURY, Wien (AT); Markus PFAFFINGER, Michelhausen (AT); Bernhard BUSETTI, Wien (AT); Robert GMEINER, Wien (AT)

(73) Assignee: CUBICURE GMBH, Wien (AT)

(21) Appl. No.: 18/862,619

(22) PCT Filed: May 3, 2023
(86) PCT No.: PCT/IB2023/054580

§ 371 Date: Nov. 4, 2024

(30) Foreign Application Priority Data
May 4, 2022 (AT) A 100/2022

(51) Int. Cl. B29C 64/35; B04B 11/06; B04B 15/02; B29C 64/357; B33Y 40/20

(52) U.S. Cl. CPC B29C 64/35; B04B 11/06; B04B 15/02; B29C 64/357; B33Y 40/20

(57) ABSTRACT

A method for at least partially removing at least partially unreacted resin adhering to components produced by a lithographic generative manufacturing process, including a) loading at least one optionally closable container with at least one component, b) arranging the container at one of a number of receiving positions of a centrifuge device that are eccentric with respect to an axis of rotation, c) centrifuging the at least one container by means of the heatable centrifuge device, whereby the adhering, at least partially unreacted resin is detached from the component, d) collecting the detached resin in an optionally removable collecting portion of the at least one container.

### CROSS-REFERENCE TO RELATED APPLICATIONS

The present application is a national phase application of PCT Application No. PCT/IB2023/054580, filed May 3, 2023, entitled “METHOD AND DEVICE FOR REMOVING RESIN ADHERING TO ADDITIVELY MANUFACTURED COMPONENTS”, which claims the benefit of Austrian Patent Application No. A 100/2022, filed May 4, 2022, each of which is incorporated by reference in its entirety.

### BACKGROUND OF THE INVENTION

### 1. Field of the Invention

The invention relates to a method and a device for at least partially removing at least partially unreacted resin adhering to components produced by means of a lithographic generative manufacturing process.

### 2. Description of the Related Art

Usually, in radiation-curing additive manufacturing processes at process temperature, liquid or viscous reactive resins are exposed to radiation locally and in high resolution and thereby cured. The first layer is cured on a construction platform or a substrate to which the three-dimensional shaped bodies, which are subsequently cured in layers, can adhere. The layered construction of the shaped bodies can take place in a bottom-up or top-down process. Examples of radiation-curing additive manufacturing processes are stereolithography, digital light processing (DLP), two-photon lithography, inkjet, volumetric 3D printing and various method combinations. In addition, said technologies and method combinations can also be combined with additional technologies (e.g. with other generative manufacturing processes, such as fused deposition modeling, subtractive methods, fiber placement systems, fiber coating devices, drilling devices, soldering devices, dye coating systems, die bonding apparatus, cold and hot plasma treatment devices, wire bonding devices, spray coating and micro-droplet systems, casting apparatus, for example, to fill components, cutting and milling devices, pick-and-place units such as robot arms and many other object manipulators). Another method is the hot lithography technology developed by the applicant. Here, viscous, highly viscous, solid and/or highly filled resins are heated non-selectively or selectively at room temperature, thereby lowering the viscosity until the resins can be processed for layering methods.

After successful printing of the 3D geometries, they are still contaminated with reactive resin residues, whereby residual resin amounts may be present at least on the surface of printed objects and/or in cavities, undercuts and object details with capillary effect. The removal of the undesired residual resin usually takes place in immersion baths with organic solvents. The solvent dissolves the residual resin adhering to the 3D printed structures or completely and thus removes it more or less well from the crosslinked photopolymer component. Said solvents can only absorb small resin quantities and the cleaning performance sometimes varies greatly depending on this loading of the solvent with resin residues.

More recent approaches in the cleaning of resinous components are based on the use of centrifuge technology (U.S. Pat. No. 10,004,578 B1, WO 2019209732 A1, U.S. Pat. No. 20,212,37358 A1). In this case, it can be possible to reuse the separated resin afterwards and thereby reduce the amount of chemical waste and the amount of resin per component required for the production process and thus reduce production and waste costs. This also indirectly contributes to resource and environmental protection.

Also, approaches for heating and evacuating centrifuges have already been described, but here the entire centrifuge chamber is always heated or evacuated, which inevitably leads to increased energy costs and longer process times due to the larger volume. An additional problem concerns the load distribution in rotation processes: since a load distribution as homogeneous as possible in the rotation drum or on the rotation circumference is essential for non-destructive operation for centrifuges, the centrifuge loading must be well planned. The freedom of design of generative processes and the high degree of individualization of additively manufactured components inevitably leads to a large variety of geometries, which is reflected in different masses or loads. Consequently, a homogeneous load distribution in a centrifuge is de facto never given and can lead to considerable problems in application.

In addition, this problem is exacerbated when centrifuging various printed components, especially when printing batches of highly viscous and/or highly filled resins made of different materials are to be cleaned at the same time. Since standard lithographic resins usually have comparatively low viscosities below 2 Pa·s at room temperature, a uniform cleaning result can be expected for centrifuge cleaning. In the case of highly viscous and/or highly filled resins, on the other hand, an elevated temperature usually has to be used for successful cleaning in order to force a reduction in the viscosity of the resin and, as a result, to improve the cleaning performance. It is often not possible to find a common temperature for components made of different resins, which provides a satisfactory cleaning result for all possible resins. Furthermore, the strength of the components to be cleaned also plays an essential role. As is known, the strength decreases with increasing temperature and this can lead to irreversible component deformation or even damage during cleaning by means of a rotational movement. This complicates the simultaneous cleaning of components made of different resins and the simultaneous cleaning of different 3D printing batches.

In additive manufacturing companies, this situation often occurs and is logistically difficult to avoid, since incoming orders, printing times per component or component batch can fluctuate by several orders of magnitude in additive processes and, especially in lithographic processes, component cleaning should take place quickly after the printing process. Especially in the recycling of centrifuged resin residues, mixing several printing materials is disastrous and as a result completely prevents the reuse of such residual resin quantities.

### SUMMARY OF THE INVENTION

The invention is therefore aimed at improving centrifuge processes and consequently reducing energy costs, increasing throughput times and guaranteeing efficient separation and improved preparation for recycling residual resin.

To achieve this object, the invention provides, according to a first aspect, a method for at least partially removing at least partially unreacted resin adhering to components produced by means of a lithographic generative manufacturing process, comprising:
Loading at least one optionally closable container with at least one component,
Arranging the container at one of a number of receiving positions of a centrifuge and/or rotation device that are eccentric with respect to an axis of rotation,
Centrifuging the at least one container by means of the centrifuge device, whereby the adhering, at least partially unreacted resin is detached from the component,
Collecting the detached resin in an optionally removable collecting portion of the at least one container.

The invention is thus based on the idea of providing at least one container into which at least one resin-contaminated, 3D-printed component can be introduced via an opening and optionally fixed, and which can optionally be closed. In this case, the component can be introduced into the container as an individual part, fixed in special receptacles or adhered to a component carrier, in particular a construction platform. In the case of fixing the component in a special receptacle, for example, existing holes in the printed component geometry can be used to fix the component, for example, with screws. In the case of the arrangement of the component on a component carrier, a printed plate, a printed plane or an existing component on which at least one lithographically generatively produced structure is placed and/or printed can be used as the component carrier. Ideally, a construction platform is fixed to one of the container walls. The wall facing away from the axis of rotation is designed in such a way that it can ideally receive centrifuged resin and conduct it into the collecting portion, such as a resin collecting basin, which is preferably located on the ground. After the at least one container has been loaded and optionally closed, it can be heated and/or vacuumed if necessary.

Alternatively or additionally, according to a preferred embodiment of the present invention, the centrifuge chamber of the centrifuge device can be heated, wherein the centrifuge chamber is preferably heated with a heating device comprising a compressor and/or fan unit and a heating element, and the heated air is thereby circulated. This is particularly effective when working with open containers. It is also possible to introduce various gases, liquids or liquid vapor. The centrifuge chamber is understood to be a chamber enclosed by a housing of the centrifuge device, which contains the containers.

Preferably, the container comprises holes to ensure better throughflow of fluid through the container.

Subsequently, one or more containers in the centrifuge may be fixed to the rotor or to a rotor platform, wherein the temperature, vacuum, etc. in the centrifuge chamber or inside the container may optionally be controlled. This is followed by circular movement of the containers about the axis of rotation of the centrifuge device, which leads to the separation of the resin from the component surface into the container. Typical rotational speeds range from 50 to 5000 and preferably from 300 to 2000 revolutions per minute. Optionally, there are additional rotational and/or pivoting movements of the container about one or more axes of rotation, which may lie inside and/or outside the container or also in combination with such axis conditions. The remaining residual resin is collected by the container wall or container lining facing away from the axis of rotation and collected in the collecting portion, i.e. a volume part of the container provided for collection. Container inner linings that are particularly suitable are, for example, fluorinated polymers, such as PTFE or FEP, but also metals such as aluminum or aluminum alloys.

A further great advantage of the invention is that the components to be cleaned, still located on the construction platform, can be introduced directly into the container. These containers can be quickly and easily separated from the rotor. This ensures a fast loading and unloading of the centrifuges and a more laborious and time-consuming removal of the components directly from the rotor can be avoided. This leads to a significant saving in process time and better centrifuge utilization in everyday production.

The invention is further based on the idea of dividing the available total volume of the centrifuge device into smaller areas separated from one another in the circumferential direction, which are arranged around the axis of rotation. Accordingly, the invention provides for the container or containers to be arranged in each case at one of a number of receiving positions of a centrifuge device that are eccentric with respect to an axis of rotation. The total volume of the centrifuge device available for receiving components is thus formed by the sum of the container volumes, a receiving position being provided for each container. In this case, the containers can preferably be fixed to the rotor of the centrifuge device at the respective receiving position in a positive-locking manner. Providing a plurality of containers instead of a single centrifuge volume increases flexibility and allows individual adjustment of the method parameters, as will be explained in more detail below.

In the case of high-viscosity resins, the separation is supported in particular by the supply of heat and is generally considerably improved. As already mentioned, increased temperature reduces the viscosity of the adhering residual resin, which facilitates separation from the component. This can be done, among other things, by supplying heat throughout the centrifuge chamber. The heat supply can be introduced into the centrifuge chamber by means of convection or radiation. Since elevated temperatures simultaneously reduce the mechanical strength of the components, which can lead to irreversible deformations or component damage during centrifuging, a compromise regarding the temperature between viscosity and strength must be found individually for each material/resin system. This makes it very difficult to clean, for example, two, three or four resin systems in a centrifuge at the same time. Here, the heatable containers offer the optimal solution if, in accordance with a preferred embodiment of the invention, the temperatures are individually adjustable for each container. Furthermore, the small containers compared to the total centrifuge volume are of great advantage, since the heating times and the energy costs incurred in the small volume of the containers are significantly lower. Corresponding optional thermal insulation of the heated containers is advantageous.

In addition, the centrifuged residual resin is collected in the container, which prevents resin contamination in the centrifuge and consequently increases throughput times. As a result, containers of different components and resins can also be centrifuged at the same time. A screen or filter installed in such a container prevents any broken-off support structures from entering the collecting portion. An optionally installed vacuum connection helps to degas the collected resin in the collecting portion already during centrifuging or at least to prevent the introduction of air or gases into the resin and resin foaming. Especially in the field of the production of medical or medical-technical components, such contamination-free use of a centrifuge unit is essential and there is only the chance of being able to reuse such resin quantities for production by collecting residual centrifuged resin quantities in, for example, disinfectable receiving containers.

Another great advantage is therefore that fast material changes are possible without contamination with other resins. For example, four different containers with four different materials can be cleaned in the same centrifuge at four different temperatures and/or pressures at the same time, provided that four containers are fixed. In an alternative embodiment, the centrifuge can actively support the active heating and/or also the degassing and/or flooding of the containers. For this purpose, either electrical and/or pneumatic and/or mechanical connections can be provided, or the container atmosphere can be regulated indirectly by the placement or introduction into a heated and/or degassed receiving zone. Alternatively, such a container can also be filled and/or flooded with a defined gas, e.g. a protective or reaction gas.

If a homogeneous mass distribution in the centrifuge is not possible due to the quantity of components or construction plates currently being cleaned, which is the rule rather than the exception in additive manufacturing, such a homogeneous mass distribution can be achieved by introducing balancing weights in the centrifuge. The spinning of balancing weights represents “dead mass” in the sense of the energy efficiency of the method. In special cases, the introduction of balancing weights is necessary to guarantee the smooth operation of the centrifuge. The homogeneous distribution can be determined with the help of scales, which can also be installed in the centrifuge.

In a special embodiment of the invention, the containers have closable openings (holes) at different height positions (in the z-axis), through which centrifuged resin can escape from the containers or is pressed out (generally radially) by centrifugal forces. By opening the suitable hole for a container, the height of the resin outlet from this container in the centrifuge can be controlled. Resin channels circulating in the centrifuge are arranged at different heights (in the direction of the axis of rotation). As a result, even differently filled containers can be separated indirectly via the centrifuge itself. An additional advantage of this embodiment is that although the resin containers can be individually preheated or heated, the degassing can take place centrally via the centrifuge and can therefore be very practicable.

In a simpler embodiment of the invention, the at least one container can also be designed without a lid and/or without removability of the resin collecting portion. Furthermore, it may be useful to insert holes or openings in certain areas of the container in order to ensure better throughflow. This can lead to faster fluid circulation when hot air or gases are introduced, which reduces the process time. It is advantageous to circulate the hot air or the hot gas in a closed circuit in order to reduce the spinning time, to keep energy costs low, but also to increase operational safety with regard to the escape of chemically contaminated gases.

In an alternative embodiment, the at least one container is designed in such a way that it is mounted such that it can rotate about one or more defined additional axes of rotation, which can lie both inside the container and outside the container, or else in any desired combinations thereof. In addition to the rotational movement of the centrifuge rotor in the centrifuge, the container can thereby perform additional rotational and pivoting movements. Alternatively, the at least one component or the component carrier can also be rotatably mounted in the interior of the container, the container itself remaining stationary on the rotor. In both cases, there are a wide variety of load change profiles and, above all, load change speeds. This is particularly relevant against the background that additively manufactured components tolerate very different G-forces, these tolerated G-forces can be direction-dependent due to material and geometry, and that cavities and undercuts can also be present in additively manufactured components, which make multiple load changes for the application of resin residues appear advantageous. In this case, it is advantageous if, depending on the embodiment, the containers can carry out purely passive rotational and pivoting movements, which result from the rotation profile and loading or mass distribution of the containers themselves, or if such additional axial movements (rotation, pivoting) are implemented by active drive mechanisms of the container carriers in the centrifuge or by special interfaces between container and centrifuge.

In a special embodiment of the invention, the resin collected in the collecting portion can be closed with a lid after completion of centrifuging and homogenized in an intermediate step. Alternatively, the resin can also be emptied from the container and optionally homogenized. The homogenization step is particularly advantageous in the case of resins filled with fillers, since the centrifugal force can lead to settling of the fillers. This can already be the case for low-filled photoresins of 0.1 to 1 wt. % of filler; in any case, however, for photoresins with filler contents of 1 to 10 wt. % and particularly pronounced for photoresins with fillers of 10 to 95 wt. %, wherein the difference between the resin density and the filler density, the morphology of introduced fillers and the general particle size and particle size distribution of the fillers in the resin as well as surface chemical effects between resin and filler can be decisive during demixing.

If necessary, the separated resin can be homogenized via various mixing methods, whereby one or more mixing methods can be carried out simultaneously or in succession. Alternatively, it is possible for several batches of separated residual resin to be combined and optionally subsequently homogenized or mixed with fresh resin and optionally homogenized. The newly obtained photoresins can then be reused for the 3D printing process. It should be noted here that, in particular, unfilled resin systems tend to have no or only negligible separation in the centrifuge process and, consequently, a homogenization step is usually superfluous.

Whether the resin centrifuged and then collected in the container can be reused can be determined by various analyses to control and ensure resin quality. A selection of classic methods for quality control and quality assurance of photoreactive resins are the measurement of resin viscosity, the measurement of the through-curing of the resin, the determination of the particle distribution in the resin, opacity measurements, spectrometric methods and/or spectroscopic methods. Typical methods for measuring resin viscosity are, for example, flow cups, rotational viscometers, capillary viscometers, falling body viscometers or Melt Flow Index (MFI) measuring instruments. The viscosity is particularly suitable as an indicator of resin quality. For example, the partial crosslinking of the resin usually leads to an increase in viscosity or the settling of filler particles leads to a viscosity gradient in the resin.

One way to measure the through-curing is to expose the photoreactive resin to a defined radiation dose or radiation intensity over a certain period of time, which should lead to the curing of a thin layer. This layer, usually a few to several hundred um thick, can then be measured (e.g. external micrometer, optical, electronic).

Particle distributions can be easily determined, for example, via a grindometer. Quality control is successful if the measurement results of the respective method are as close as possible to the result of the starting resin. The maximum possible deviation of the measurement results from the starting resin/fresh resin is strongly dependent on the respective resin. Meaningful tolerance ranges are in any case ±5%, ±10%, ±15%, ±20%, ±25% or higher based on the respective measured value of the starting resin/fresh resin.

The at least partially unreacted resin to be removed from the component is preferably a photoresin. Photoresins usually consist of (end-group-modified, reactive) oligomers, low molecular weight mono-and/or multifunctional reactive diluents, fillers, additives and/or at least one photoinitiator. Examples of (end-group-modified, reactive) oligomers are, in principle, all polymers, polyaddition and polycondensation products, for example polyethers, polyesters, polyurethanes, polycarbonates, polyamides, polythioethers, polythioesters, silicones, etc. In most cases, the reactive components have at least one or more reactive end group(s) which cure on exposure to radiation of a suitable wavelength with decomposition of at least one photoinitiator and form a solid, crosslinked polymer. Examples of reactive end groups comprise unsaturated double bonds, vinyl, acrylates, methacrylates, acrylamides, allyl compounds, norbornenes, vinyl ethers, epoxides, oxetanes, maleimides, thiols, to name a few. Typical photoinitiators form radicals, cations, anions or other active species (e.g. Grubbs catalysts) on decomposition or activation, which trigger the polymerization on irradiation with certain wavelengths and usually lead to a crosslinked photopolymer.

Photoresins can also contain a high proportion of organic, inorganic, ceramic and/or metallic fillers and lead to hybrid materials after polymerization. Fillers may also be oligomers, prepolymers and/or polymers. Typical filler contents range from 1 to 95 wt. %. After cleaning, for example, inorganic, ceramic or metallic filled photopolymers can be further processed into ceramics or metals in debindering and sintering processes. In addition, said photopolymers can also consist of dual-cure systems, with a first crosslinking for shaping taking place in the 3D printing process, and a second crosslinking being triggered, for example thermally, in downstream processes.

The at least partially unreacted resin to be removed from the component is preferably a medium-viscosity resin with a viscosity of 5 to 30 Pa·s at room temperature (20° C.), a high-viscosity resin with a viscosity of 30 to several hundred pascal seconds, or a resin with a very high viscosity of 1,000 Pa·s and higher.

The method according to the invention is preferably embedded in a process chain of a manufacturing process. In general, the process chain comprises as an initial step the digital preparation, in which the three-dimensional components to be produced are digitally prepared, after which the components are printed in a lithography-based additive manufacturing process. Thereafter, one or more optional pre-cleaning step(s) of the components may optionally take place. The components are then cleaned in accordance with the cleaning method according to the invention, and the final three-dimensional component is finally obtained in one or more downstream process(es).

In the digital preparation step, existing 3D data of a component are optimized and prepared for the printing process according to the specifics of the subsequent generative manufacturing process. These processing steps on the 3D model may comprise, among other things, data error analysis and possibly data repair, scaling, placement of the 3D models on the digital construction platform, geometric compensations, for example, of overpolymerization occurring in radiation-curing methods, creation of support geometries and the generation of layer information. All sub-steps can be done manually, semi-automated or fully automated. Alternatively, the print data can also be created directly in a CAD software according to process-dependent design guidelines including all sub-steps.

In a photopolymerization-based printing process, the photoresins are irradiated with local and high-resolution radiation in a lithography-based method, with the irradiated areas curing to form a solid. The process takes place in stages or continuously and the previously prepared three-dimensional structures are built up. In this case, the components are usually located on a construction platform. Construction platforms can exist in a wide variety of embodiments. They can be manufactured from various materials, such as metals, ceramics, plastics, hybrid materials, composites or composites. They usually have a smooth, flat surface, but roughened surfaces, recesses and/or holes may also be advantageous. Recesses and holes in the construction platform can be useful for centrifuge cleaning insofar as the resin can also be centrifuged through the holes and recesses from the component to the construction platform and through the recesses and holes of the construction platform by the centrifugal forces.

The construction platforms and/or components can be made uniquely identifiable and distinguishable by means of a unique identifier (UID) (e.g. by means of chips, barcode, QR code, RFID, numbering, NFC, etc.). This also facilitates identification along the entire process chain, from the digital preparation of the parts to 3D printing, through postprocessing to quality control of the end component or even installation in the end product.

After a successful 3D printing process, the components can be finalized or refined. These processes are referred to as postprocessing and comprise a variety of downstream processes to obtain the final component properties. Typical postprocessing steps are cleaning by means of centrifugal forces, cleaning with solvents using turbulent flows, directed jets, ultrasound, steam, aerosols and/or in pressure cycling processes, cleaning by means of gases and/or directed gas streams (e.g. compressed air, heated compressed air), drying components, post-curing, which can be carried out in various ways (e.g. thermal, radiation-induced, microwaves), the removal of support structures as well as dyeing, coating (e.g. metal or plastic coating), painting, equipping 3D printed components (e.g. with microchips, pins, cables, electrical contacts). Furthermore, other generative manufacturing processes, such as fused deposition modeling, subtractive methods, fiber placement systems, fiber coating devices, drilling devices, soldering devices, dye coating systems, die bonding apparatus, cold and hot plasma treatment devices, wire bonding devices, spray coating and micro-droplet systems, casting apparatus, to fill components, cutting and milling devices, pick-and-place units such as robot arms and many other object manipulators can be used. If appropriate, all the postprocessing methods mentioned can be carried out in any order, not at all, simultaneously, consecutively and as often as desired, as well as manually and/or semi-automatically and/or fully automatically. At this point, it should also be mentioned that postprocessing steps can optionally also take place before the centrifuge cleaning. For example, a solvent cleaning can be carried out beforehand and the centrifuge step can be used to separate the residual solvent located on the components.

After postprocessing, a final 3D component is obtained. Examples of such 3D components are medical, dental and orthodontic applications such as, for example, intraoral applications such as, for example, regulations, aligners, splints or attachments, medical technology products, food industry, electronic components such as, for example, plug connectors, connectors, plugs or housings, 3D printed shoe soles, parts for the aerospace industry, applications in the military sector, applications in the field of consumer goods, applications in the field of mobility, automotive and electromobility, 3D printed parts for use in the energy sector, applications in the sports sector such as, for example, shoe soles or cushioning elements, applications in the field of printed electronics, applications in the field of tool manufacturing, to name just a few.

According to a second aspect, the invention relates to a device for at least partially removing at least partially unreacted resin adhering to components produced by means of a lithographic generative manufacturing process, in particular for carrying out a method, in particular for carrying out the method according to the invention, comprising a centrifuge device with a rotor drivable for rotation about an axis of rotation and a plurality of containers each with a container opening provided for the loading with at least one component and fixing means for fixing the at least one component in the container interior, where the rotor comprises a plurality of receptacles, eccentric with respect to the axis of rotation, for the eccentric arrangement of each single of the plurality of containers, where the containers optionally comprise a closure part for closing the container opening, and an optional collecting portion for collecting detached resin.

Preferred embodiments of the device according to the invention are specified in the subclaims.

### BRIEF DESCRIPTION OF THE DRAWINGS

The invention is explained in more detail below with reference to exemplary embodiments illustrated in the figures.

FIGS. 1a-1e show various embodiments of a centrifuge device with rigidly arranged containers,

FIG. 2 shows an alternative embodiment of a centrifuge device with components rotatably mounted relative to the centrifuge platform,

FIGS. 3a-e show several embodiments of a container for arrangement in the centrifuge device,

FIGS. 4a-d show various geometric options for the container walls,

FIG. 5 shows an exemplary sequence of the centrifuging method,

FIG. 6 shows an exemplary reuse cycle,

FIGS. 7a, 7b and 7c show alternative possibilities of a centrifuge construction,

FIG. 8 shows an embodiment of a container with a specially designed wall, and

FIG. 9 shows a view of a container from above.

### DETAILED DESCRIPTION

The figures shown and described below are provided only for a better understanding of the invention and do not constitute a limitation of the invention. The dimensions of the drawn components can vary as desired. For easier understanding of the invention, only the essential assemblies and parts of the invention are shown. For example, fastenings, connections and/or translations can be realized in a wide variety of ways.

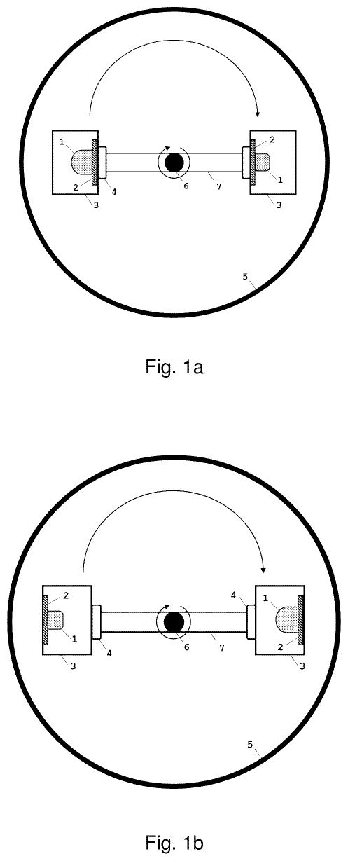

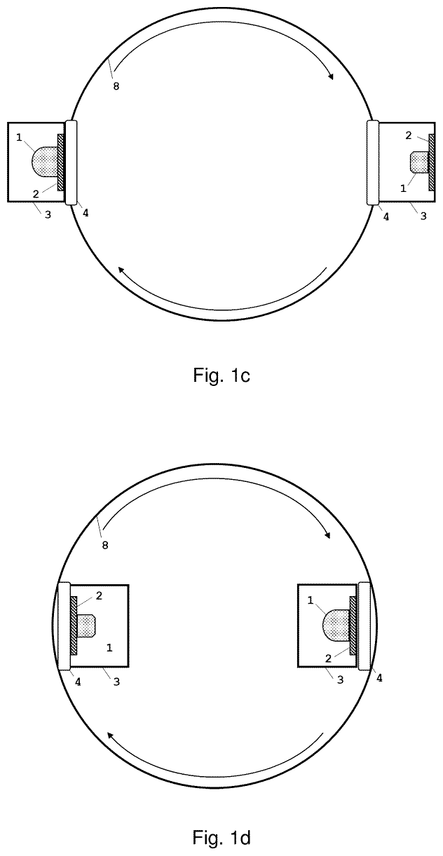

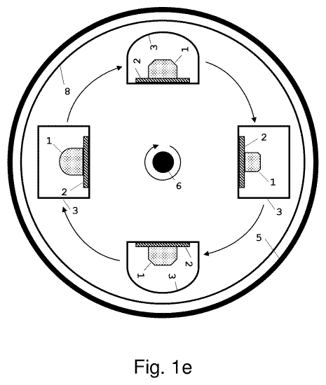

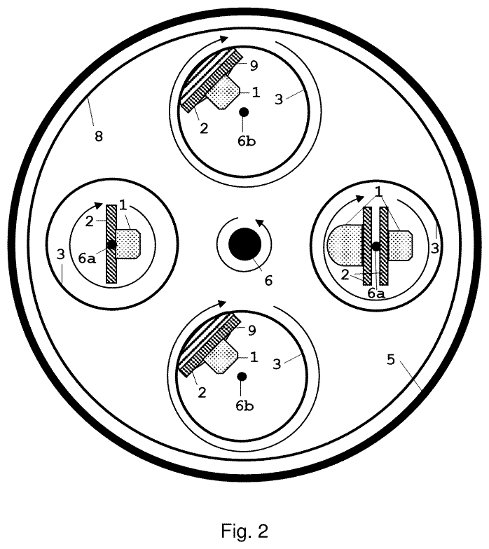

FIG. 1a shows a centrifuge device comprising a static outer wall 5, a rotor axis of rotation 6 and a rotor 7 driven to 15 rotate about the rotor axis of rotation. At opposite ends of the rotor 7, a fixing device 4 for fixing the container 3 to the rotor 7 is arranged at a respective receiving position. At least one component 1, which adheres to a construction platform 2 and was produced by means of a lithographic generative manufacturing process and to which at least partially unreacted resin adheres, which is detached by centrifuging, is arranged or fixed in the container 3. The construction platform 2 together with the component 1 are arranged in the container 3 in such a way that the side of the construction platform 2 facing the component 1 is directed radially outward.

FIG. 1b shows a centrifuge construction similar to FIG. 1a, wherein the construction platform 2 together with the associated component(s) 1 are arranged in the container 3 in such a way that the side of the construction platform 2 facing away from the component 1 is directed radially outward.

FIGS. 1c and 1d show a modified embodiment of the centrifuge device with a rotor platform 8 driven to rotate about a central axis of rotation. The rotor platform 8 has a plurality (here: two) of eccentric receiving positions for receiving in each case one container 3, wherein in each case one fixing device 4 is provided for mounting the container 3 on the rotor platform 8. The term rotor platform does not represent a geometric restriction of the rotating device.

While the containers 3 are attached to the outer wall of the rotor platform 8 in the embodiment according to FIG. 1c, they are mounted to the inner wall of the rotor platform in the embodiment according to FIG. 1d. Accordingly, the construction platform 2 together with the component 1 is arranged in the container 3 in such a way that either the side facing the component 1 (FIG. 1c) or the side facing away from the component 1 (FIG. 1d) of the construction platform is directed radially outwards.

FIG. 1e shows an alternative embodiment of the centrifuge device with a rotor platform 8, on which one or more, in the special case four, containers 3 are fixed.

The components 1 located in FIGS. 1a-e, which are optionally printed on construction platforms 2, can be facing the axis of rotation, facing away from it or fixed in any other form.

FIG. 2 shows a centrifuge device with a rotor platform 8, wherein the base rotation about the axis of rotation 6 can be superposed with a further rotation about a further axis of rotation 6a arranged eccentrically to the axis of rotation 6. For this purpose, according to a first embodiment, the respective container 3 is arranged statically relative to the rotating rotor platform 8, and the associated construction platform 2 is mounted rotatably relative to the container 3 about the further rotor axis 6a. According to a second embodiment, the container 3 is mounted rotatably about the further rotor axis 6b and the associated construction platform 2 is firmly fixed to the container 3. In all of the examples given in FIGS. 1, 2, and 8, the movably mounted assemblies may rotate arbitrarily both clockwise and counterclockwise about the axis of rotation and/or axes of rotation.

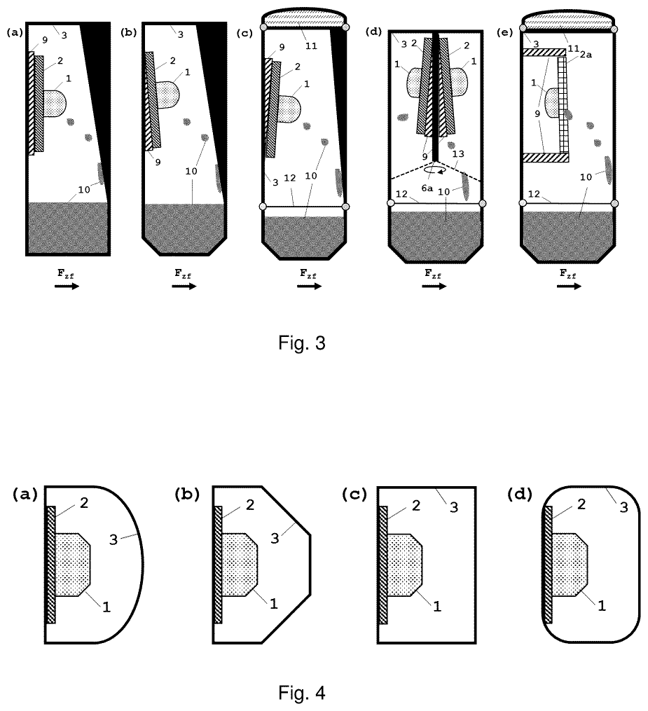

FIGS. 3a-e each show a side view of a container 3, wherein the construction platform 2 is fixed to the component 1 in the container 3 via a fixing device 9. By means of the centrifugal forces (Fzf), the resin 10 can be detached from the component 1 and collected in a collecting portion or resin reservoir 12 at the bottom of the container 3. Ideally, the wall(s) optionally opposite the component 1 is/are inclined slightly obliquely downward, so that the resin can more easily enter the resin reservoir due to the centrifugal forces. The construction platform 2 may be fixed to the fixing device 9 at various angles. In FIG. 3a, the construction platform 2 is arranged at a right angle to the centrifugal force. In FIG. 3b, the construction platform 2 is tilted slightly upward compared to the orientation of FIG. 3a, and in FIG. 3c, the construction platform 2 is tilted slightly downward compared to the orientation of FIG. 3a.

In FIG. 3c, the container 3 is also equipped with a lid 11 in order to be able to close the container 3. Furthermore, the resin reservoir 12 is designed to be removable and can therefore be emptied more easily.

FIG. 3d shows a container 3, in which two construction platforms 2 are mounted rotatably about a further axis of rotation 6a, and which additionally has a permeable filter or a permeable screen 13, which is arranged between the component 1 and the resin reservoir 12.

FIG. 3e shows the case of a resin-permeable construction platform 2a, wherein the resin permeability can be realized by recesses or holes in the construction platform 2a. Here, the resin residues are separated from the component 1 to the construction platform 2a by the centrifugal forces and then pass through the recesses or holes into the optionally removable resin reservoir 12.

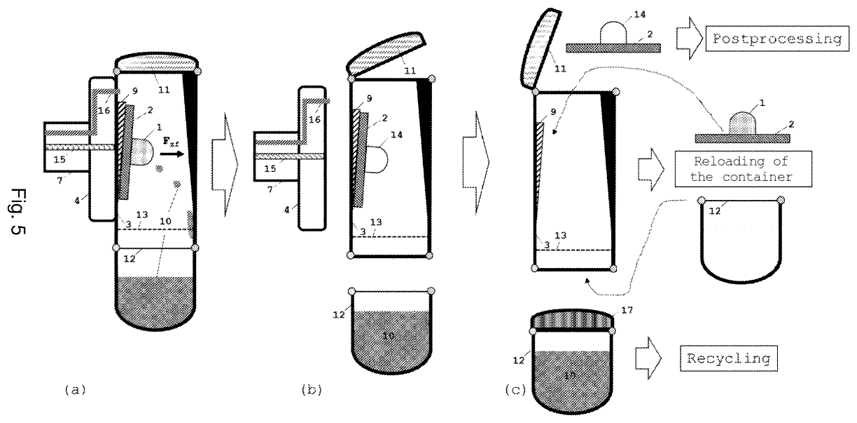

FIGS. 4a-d show various geometric options for the container wall and the container rear wall from above. They can be, for example, rectangular, oval, trapezoidal or polygonal geometries.

FIGS. 5a-c describe an example structure of a container 3 and an example process flow. FIG. 4a shows a container 3, which is fixed to the rotor 7 via a fixing device 4. The rotor 7 contains a power supply and/or cable 15, which can operate a heater or ensure data transfer, for example, as well as a vacuum line or a gas and/or liquid inlet 16, via which the container 3 can be flooded. This rotor 7 may also be a rotor platform 8. In FIG. 4a, the container 3 with resinified components 1, closed with a lid 11, is exposed to centrifugal forces (Fzf) on a construction platform 2, which is mounted on the container wall via a construction platform fastening 9. Resin residues 10 are centrifuged off the component 1, pressed through a screen or filter structure 13 and collected in the resin reservoir 12. The screen 13 primarily prevents any detaching components or support structures from entering the resin reservoir 12. After the centrifuging process has ended (FIG. 4b), the largely resin-free parts 14 can be ejected from the centrifuge together with the construction platform 2 by opening the container lid 11. Similarly, the resin reservoir 12 filled with resin 10 may be removed from the container 3. In step (c), the cleaned components 14 are fed to the further postprocessing sequence, and the separated resin reservoir 12 is fed to the recycling cycle after being optionally closed with a closure cap 17. Subsequently, the container 3 can be loaded with a new construction platform 2 with resinous components 1 and a new, cleaned resin reservoir 12 can be attached to the container 3.

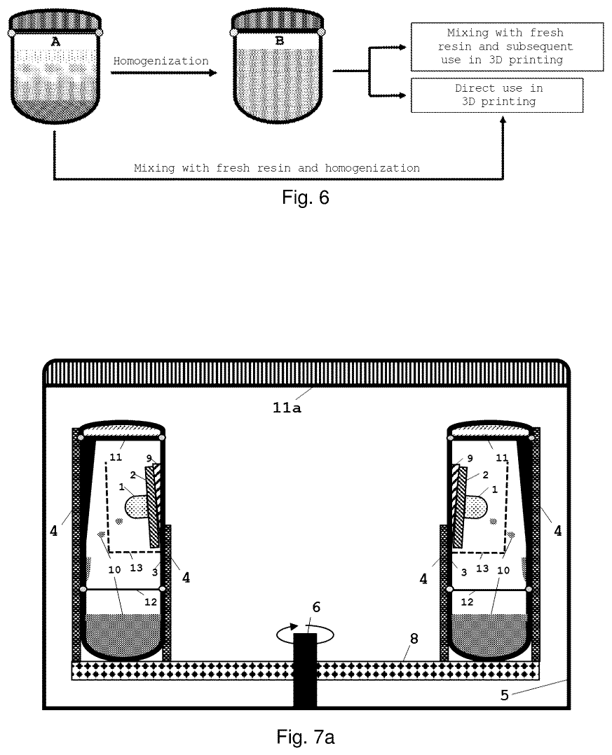

FIG. 6 shows possible recycling cycles of the separated residual resin. Here, it is possible to mix the separated residual resin directly with fresh resin and then process it again in the 3D printer. Furthermore, it is possible for one or more separated residual resin batches to be homogenized and then introduced into the 3D printing process or for the homogenized residual resin to be mixed with fresh resin before being returned to the 3D printer.

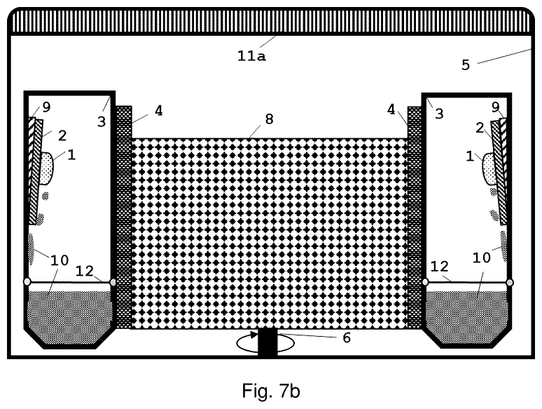

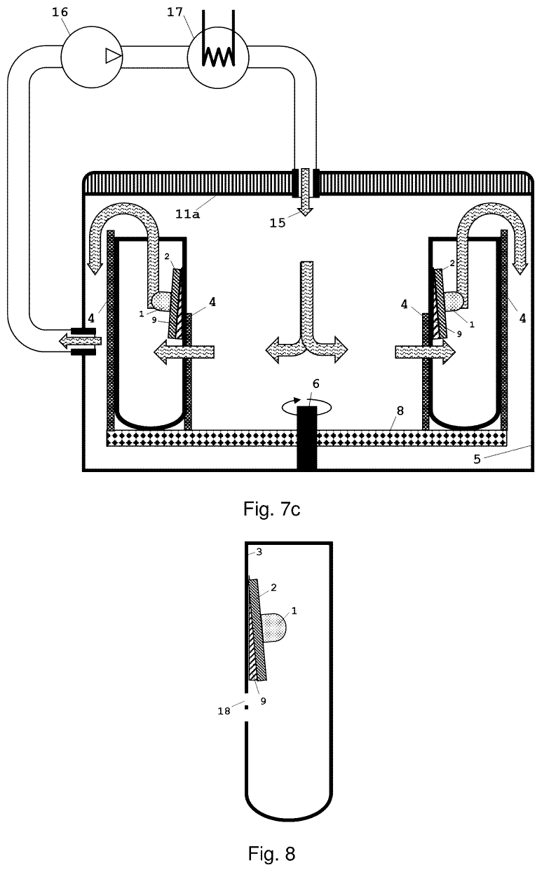

FIG. 7a shows the cross-sectional view of a preferred centrifuge construction with containers. In this case, the containers 3 are fixed by means of a fixing device 4 on a rotor platform 8, which rotates about a rotor axis 6. The outer one of the two fixing devices 4 preferably corresponds to a solid annular construction that is fixed along the outer edge of the rotor platform 8 and holds the containers 3 on the rotor plate. The fixing devices 4 can also be designed in such a way that the container is fixed obliquely to the rotor axis 6. The outer housing 5 of the centrifuge can be closed with a lid 11a. Optionally, the centrifuge chamber can also be heated, for example with hot air, infrared radiators and/or heating sleeves.

In an alternative embodiment (FIG. 7b) of the centrifuge construction, the containers 3 are mounted in such a way that the centrifugal forces acting on the components 1 point towards the printed surface, for example a construction platform 2, so that the components 1 are mounted pointing or standing in the direction of the axis of rotation 6. This is particularly preferred if the components 1 are sensitive to tensile stress or if special component geometries can thereby ensure a preferred resin outflow. Optionally, the centrifuge chamber enclosed by the outer housing 5 and the lid 11a can also be heated (e.g. hot air, infrared radiators and/or heating collars), evacuated and/or flushed with steam or gases.

FIG. 7c shows a further embodiment of the centrifuge, in which case the centrifuge chamber is connected to a heating device consisting of a compressor and/or fan unit and/or pump unit 16 (e.g. radial or axial compressor) and a heating element 17 (e.g. heating cartridge or heating spiral). A possible movement of the air flow 15 is shown.

In FIG. 7c, the containers 3 are designed without lids and are provided with holes in preferred locations to allow better throughflow of preheated air. As indicated in FIG. 7c, the preheated air 15 is preferably circulated during the centrifuging method in order to keep the energy input low.

An example of holes or recesses 18 in the container wall 3 is shown in FIG. 8 to ensure better throughflow with fluids (e.g., air). These are preferably placed on the side facing away from the resin collecting wall.

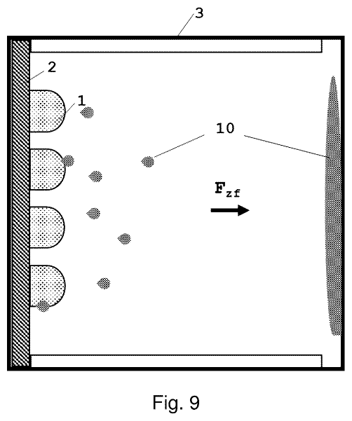

FIG. 9 shows a top view of a container 3. The container is designed in such a way that the construction platform 2 with the resinified components 1 can easily be inserted into and removed from the container via a positive-locking rail. The positive-locking rail also has the advantage that safety is guaranteed for the user and no additional fixing measures are necessary. Alternatively, construction platforms could also be provided with a lateral groove, which are then pushed in a positive-locking manner into a guide provided for this purpose and are thus also locked for the spinning process.

1-22. (canceled)

23. A method for at least partially removing at least partially unreacted resin adhering to components produced by a lithographic generative manufacturing process, comprising:
loading at least one container with at least one component;
arranging the container at one of a number of receiving positions of a centrifuge device that are eccentric with respect to an axis of rotation;
centrifuging the at least one container by the centrifuge device whereby the adhering, at least partially unreacted resin, is detached from the component; and
collecting the detached resin in a collecting portion of the at least one container.

24. The method according to claim 23, wherein collecting portion of the at least one container is removable.

25. The method according to claim 23, wherein the at least one component is arranged in the container while the at least one component is adhering on a component carrier.

26. The method according to claim 25, wherein the component carrier comprises a construction platform.

27. The method according to claim 24, wherein the at least one component or the component carrier is fixed to the container.

28. The method according to claim 27, wherein the at least one component or the component carrier is fixed to a side or wall of the container facing toward or away from the axis of rotation of the centrifuge device.

29. The method according to claim 23, wherein a centrifuge chamber of the centrifuge device is heated, and the heated air is thereby circulated.

30. The method according to claim 23, wherein the container comprises holes to provide throughflow of fluid through the container.

31. The method according to claim 23, wherein the at least one container is closed before centrifuging.

32. The method according to claim 23, wherein the at least one component arranged in the container is heated by a heating device at least one of before and during centrifuging.

33. The method according to claim 23, wherein:
the step of loading comprises arranging the at least one component in a first container and arranging at least one further component in a second container; and
the heating of the first and second containers is controlled such that a different temperature prevails in the first container than in the second container during centrifuging.

34. The method according to claim 23, wherein an interior of the container is placed under reduced pressure after closing.

35. The method according to claim 23, wherein the at least one container is rotated during the centrifuging relative to a rotor of the centrifuge device carrying the at least one container.

36. The method according to claim 23, wherein the collecting portion together with the detached resin arranged therein is separated from the container.

37. The method according to claim 23, wherein the resin collected in the collecting portion is returned for use in the lithographic generative manufacturing of process.

38. A device for at least partially removing at least partially unreacted resin adhering to components produced by a lithographic generative manufacturing process, comprising
a centrifuge device with a rotor drivable for rotation about an axis of rotation; and
a plurality of containers each with a container opening provided for loading at least one component and a fixing arrangement for fixing the at least one component in the container interior;
wherein the rotor comprises a plurality of receptacles, eccentric with respect to the axis of rotation, for the eccentric arrangement of each of the plurality of containers.

39. The device according to claim 38, wherein:
the centrifuge device comprises heating devices, each of which is assigned to a respective container; and
means are provided for individually controlling the heating devices, so that the temperature of each container can be adjusted individually.

40. The device according to claim 38, wherein the centrifuge device comprises at least one vacuum source, which is fluidically connected to the interior of the containers via a controllable closure part.

41. The device according to claim 38, wherein the containers are rotatably mounted on the rotor relative to the rotor.

42. The device according to claim 38, wherein the containers each have a fixing device for fixing the at least one component or a component carrier on a side or wall of the container facing toward or away from the axis of rotation of the centrifuge device.

43. The device according to claim 38, wherein the containers each comprise a retaining device arranged upstream of the collecting portion.

44. The device according to claim 38, wherein the collecting portion is detachably connected to the container.

45. The device according to claim 44, wherein the collecting portion comprises a collecting trough.

46. The device according to claim 38, wherein the collecting portion is fluidically connected to a side or wall of the container facing away from the axis of rotation of the centrifuge device.

47. The device according to claim 38, wherein:
the collecting portion comprises a collecting trough, on the wall, facing away from the axis of rotation;
the container opening is closable; and
the centrifuge device comprises at least one annular collecting channel surrounding a circular path of the opening.

48. The device according to claim 38, wherein a centrifuge chamber of the centrifuge device is connected to a heating element and at least one of a compressor and a fan unit.
